(19) United States
(12) Patent Application Publication
(10) Pub. No.: US 2014/0157173 A1
(43) Pub. Date: Jun. 5, 2014

(54) ELECTRONIC APPARATUS AND METHOD OF CONTROLLING THE SAME

(71) Applicant: KABUSHIKI KAISHA TOSHIBA, Tokyo (JP)

(72) Inventor: Shunsuke Takayama, Tachikawa-shi (JP)

(21) Appl. No.: 13/944,157

(22) Filed: Jul. 17, 2013

(30) Foreign Application Priority Data
Nov. 30, 2012 (JP) 2012-263612

(51) Int. Cl. G06F 3/0484

(52) U.S. Cl. CPC G06F 3/0484
USPC 715/771

(57) ABSTRACT

According to one embodiment, an electronic apparatus executes a desktop application displayed on a display screen on a desktop and a full-screen application displayed as a full-screen picture on the display screen. Each of the applications open a file comprising an extension in a file name of the file. The apparatus includes a default application setting selector. The default application setting selector selects one of the desktop application and the full-screen application as a default application which opens the file, based on at least one of system configuration of the apparatus and a usage state of applications executed by the apparatus, and associates the selected application with the extension, or recommends the selected application as the default application to be associated with the extension.

### CROSS-REFERENCE TO RELATED APPLICATIONS

This application is based upon and claims the benefit of priority from Japanese Patent Application No. 2012-263612, filed Nov. 30, 2012, the entire contents of which are incorporated herein by reference.

### FIELD

Embodiments described herein relate generally to an electronic apparatus, and a method of controlling the same.

### BACKGROUND

Windows® are on sale from Microsoft® at present. New user interface has been introduced into Windows 8. Since the new user interface is basically started in the full screen, thus the font and components thereof are displayed in large size, and the new user interface can be easily operated even with a touchpanel. On the other hand, it is also possible to start conventional desktop applications in Windows 8.

Although the new user interface is suitable for devices which are used by touch operation, such as tablet computers, it is convenient for the user to use conventional applications, which enables more detailed operations, on desktop and notebook computers.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view of an example of an external appearance of an electronic apparatus according to an embodiment.

FIG. 2 is an exemplary block diagram illustrating an example of system configuration of the electronic apparatus according to the embodiment.

FIG. 3 is an exemplary perspective view of another example of an external appearance of the electronic apparatus according to the embodiment.

FIG. 4 is an exemplary block diagram illustrating another example of system configuration of the electronic apparatus according to the embodiment.

FIG. 5 is an exemplary flowchart of an example of process of associating a default application with an extension.

FIG. 6 is an exemplary diagram illustrating an example of a window which is displayed by an extension association setting application program, after the default applications are associated with respective extensions.

FIG. 7 is an exemplary block diagram illustrating an example of system configuration of an electronic apparatus according to a second embodiment.

FIG. 8 is an exemplary block diagram illustrating another example of system configuration of the electronic apparatus according to the second embodiment.

FIG. 9 is an exemplary diagram illustrating an example of a pop-up window which is presented to the user when desktop applications are frequently used.

FIG. 10 is an exemplary diagram illustrating an example of a pop-up window which is presented to the user when full-screen applications are frequently used.

FIG. 11 is an exemplary diagram illustrating an example of a window for causing the user to select the type of application started with priority when a file is selected.

FIG. 12 is an exemplary diagram illustrating an example of a window which is displayed on an LCD, when the user selects full-screen applications and the default applications for extensions are changed.

### DETAILED DESCRIPTION

Various embodiments will be described hereinafter with reference to the accompanying drawings.

In general, according to one embodiment, an electronic apparatus configured to execute a desktop application displayed on a display screen on a desktop and a full-screen application displayed as a full-screen picture on the display screen. Each of the applications is configured to open a file comprising an extension in a file name of the file. The apparatus comprises a default application setting selector. The default application setting selector is configured to select one of the desktop application and the full-screen application as a default application configured to open the file, based on at least one of system configuration of the apparatus and a usage state of applications executed by the apparatus, and to associate the selected application with the extension, or recommend the selected application as the default application to be associated with the extension.

Windows 8 are on sale from Microsoft at present. Two types of applications are executed on Windows 8, that is, conventional applications which are displayed on a desktop picture of the display screen, and applications which are displayed on the whole display screen. The applications which are displayed on the whole display screen have a user interface which is based on the premise that the applications are operated by touch operation.

Since applications of the two types can be executed under Windows 8, two types of computers are provided as mobile computers. One type consists of notebook computers, which have conventional keyboards. The other consists of tablet computers, which lack keyboards.

There are two types of applications. Applications of one type have a user interface which is based on the premise that the application is displayed on the whole display screen, and operated by touch operation. Applications of this type will be referred to as “full-screen applications” hereinafter. Full-screen applications are application programs which are basically started full-screen.

Full-screen applications have fonts and components of large sizes, which are displayed by the full-screen applications, such that they can be easily operated with a touchpanel.

The other type of application is applications which are displayed on the desktop of the display screen. In the following explanation, applications of the other type will be referred to as “desktop applications”. The desktop applications have a user interface which is based on the premise that the applications are operated with a pointing device such as a touchmouse or a touchpad.

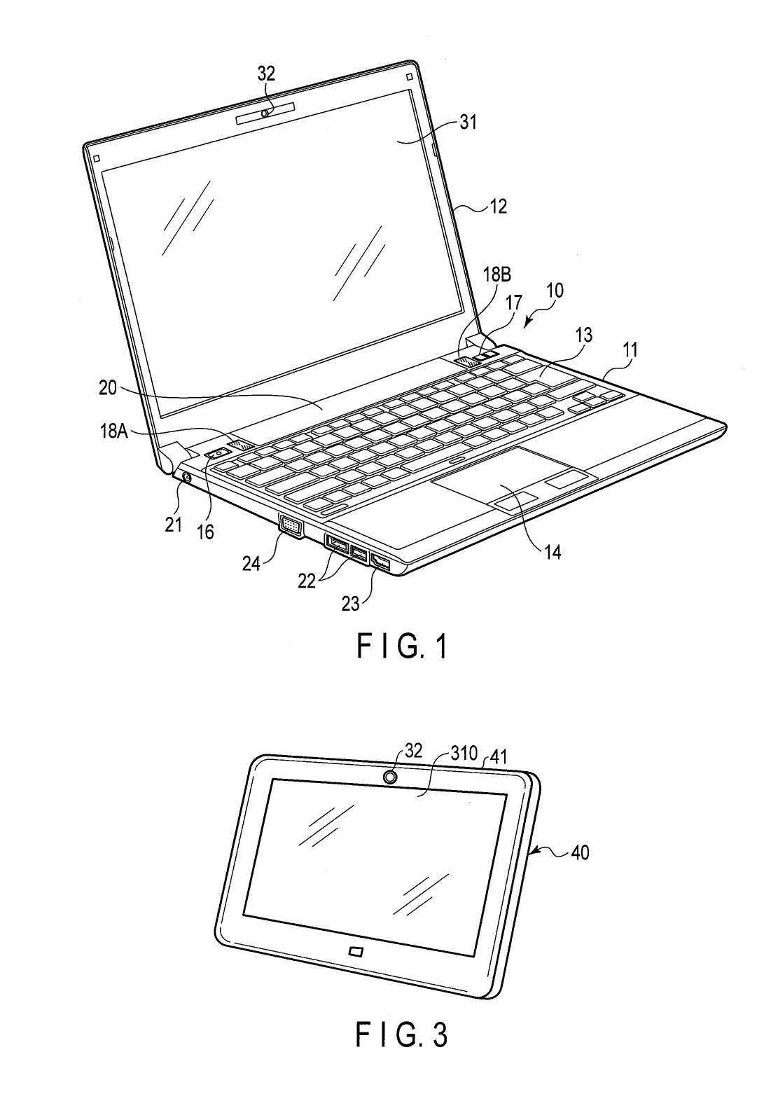

First, configuration of an electronic apparatus according to an embodiment will be explained hereinafter with reference to FIG. 1 to FIG. 4. The electronic apparatus is realized as, for example, a notebook computer, a tablet computer, or another information processing apparatus.

FIG. 1 is a perspective view of a notebook computer 10, which is in a state where a display unit is opened, as viewed from the front. The computer 10 is configured to receive electric power from a battery 20. The computer 10 comprises a computer main body 11, and a display unit 12. The display unit 12 includes a display device such as a liquid crystal display (LCD) 31. A camera (webcam) 32 is disposed in an upper end part of the display unit 12.

The display unit 12 is attached to the computer main body 11, such that the display unit 12 is rotatable between an open position in which an upper surface of the computer main body 11 is exposed and a closed position in which the upper surface of the computer main body 11 is covered with the display unit 12. The computer main body 11 includes a housing which has a thin box shape. A keyboard 13, a touchpad 14, a power switch 16 to turn on/off the computer 10, some function buttons 17, and speakers 18A and 18B are arranged on the upper surface of the computer main body 11.

The computer main body 11 is also provided with a power supply connector 21. The power supply connector 21 is provided in a side surface, for example, a left side surface of the computer main body 11. An external power supply device is detachably connected to the power supply connector 21. An AC adaptor can be used as the external power supply device. The AC adaptor is a power supply device which converts a commercial power supply (AC electric power) to DC electric power.

The battery 20 is detachably attached to, for example, a rear end part of the computer main body 11. The battery 20 may be a battery which is contained in the computer 10.

The computer 10 is driven by electric power from the external power supply device or the battery 20. When an external power supply device is connected to the power supply connector 21 of the computer 10, the computer 10 is driven by electric power from the external power supply device. The electric power from the external power supply device is also used for charging the battery 20. In a time period for which no external power supply device is connected to the power supply connector 21 of the computer 10, the computer 10 is driven by the electric power from the battery 20.

In addition, the computer main body 11 is provided with some USB ports 22, a High-Definition Multimedia Interface (HDMI) output terminal 23, and an RGB port 24.

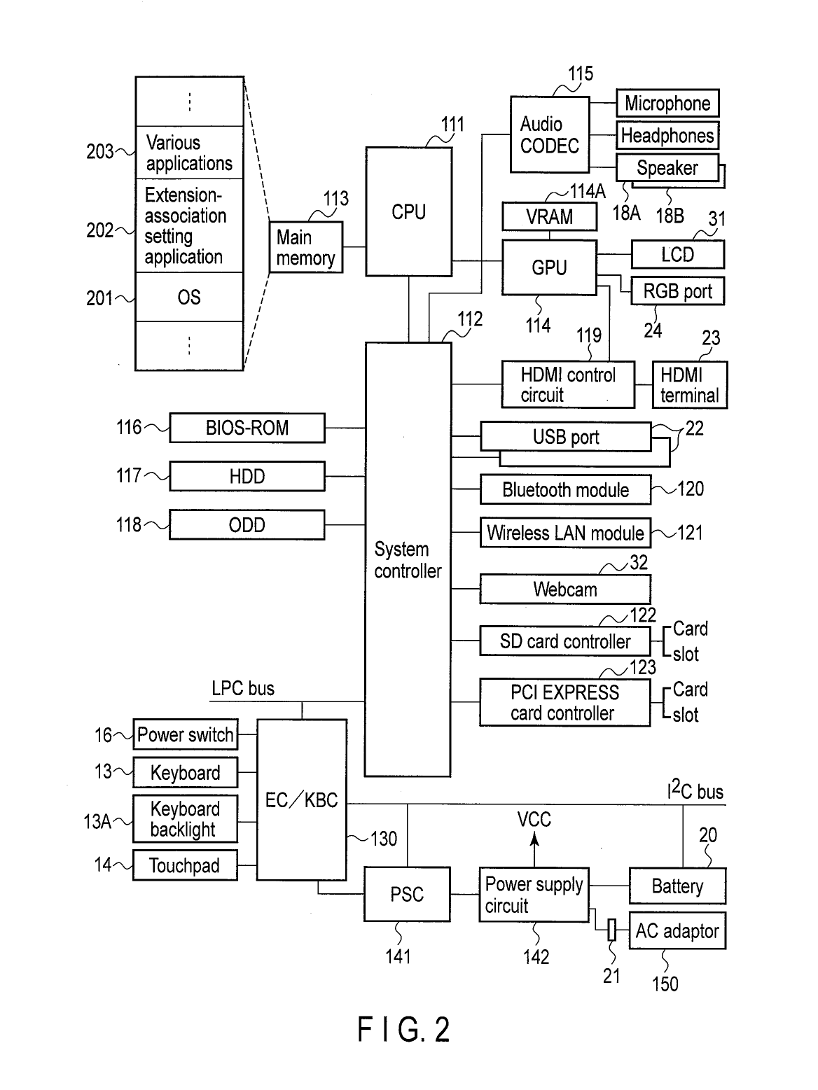

FIG. 2 illustrates system configuration of the computer 10. The computer 10 comprises a CPU 111, a system controller 112, a main memory 113, a graphics processing unit (GPU) 114, an audio CODEC 115, a BIOS-ROM 116, a hard disk drive (HDD) 117, an optical disk drive (ODD) 118, a Bluetooth (registered trademark) module 120, a wireless LAN module 121, an SD card controller 122, a PCI EXPRESS card controller 123, an embedded controller/keyboard controller IC (EC/KBC) 130, a keyboard backlight 13A, a power supply controller (PSC) 141, and a power supply circuit 142.

The CPU 111 is a processor which controls operation of each component of the computer 10. The CPU 111 executes various software programs which are loaded from the HDD 117 into the main memory 113. The software programs include an operating system (OS) 201, an extension-association setting application program 202, and various application programs 203. The various application programs 203 include the above desktop and full-screen applications.

The CPU 11 also executes a basic input/output system (BIOS) which is stored in the BIOS-ROM 116 that is a nonvolatile memory. The BIOS is a system program for controlling hardware.

The GPU 114 is a display controller which controls the LCD 31 that is used as a display monitor of the computer 10. The GPU 114 generates a display signal (LVDS) signal, which is to be supplied to the LCD 31, from display data that is stored in a video memory (VRAM) 114A. The GPU 114 can also generate an analog RGB signal and an HDMI video signal from the display data. The analog RGB signal is supplied to an external display through the RGB port 24. The HDMI output terminal 23 can transmit the HDMI video signal (digital image signal which is not compressed) and a digital audio signal to the external display through a cable. The HDMI control circuit 119 is an interface configured to transmit the HDMI video signal and the digital audio signal to the external display through the HDMI output terminal 23.

The system controller 112 is a bridge device which connects the CPU 111 with each component. The system controller 112 includes a serial ATA controller configured to control the hard disk drive (HDD) 117 and the optical disk drive (ODD) 118. The system controller 112 also executes communication with each device on a Low Pin Count (LPC) bus.

The EC/KBC 130 is connected to the LPC bus. The EC/KBC 130, the power supply controller (PSC) 141, and the battery 20 are connected to each other through a serial bus such as an I²C bus.

The EC/KBC 130 is an electric power management controller configured to perform electric power management of the computer 10. For example, the EC/KBC 130 is realized as a single-chip microcomputer which includes a keyboard controller that controls the keyboard (KB) 13 and the touchpad 14. The EC/KBC 130 has a function of turning on/off the computer 10, in response to user operation of the power switch 16. Control to turn on/off the computer 10 is executed by cooperation of the EC/KBC 130 with the power supply controller (PSC) 141. When the power supply controller (PSC) 141 receives an ON signal transmitted from the EC/KBC 130, the power supply controller (PSC) 141 controls the power supply circuit 142 and turns on the computer 10. When the power supply controller (PSC) 141 receives an OFF signal transmitted from the EC/KBC 130, the power supply controller (PSC) 141 controls the power supply circuit 142 and turns off the computer 10. The EC/KBC 130, the power supply controller (PSC) 141, and the power supply circuit 142 operate by electric power from the battery 20 or the AC adaptor 150, even during a time period for which the computer 10 is in a power-off state.

The EC/KBC 130 can also turn on/off the keyboard backlight 13A which is disposed on a back surface of the keyboard 13. In addition, the EC/KBC 130 is connected to a panel opening/closing switch 131 which is configured to detect opening/closing of the display unit 12. The EC/KBC 130 can turn on the computer 10, also when the panel opening/closing switch 131 detects that the display unit 12 is opened.

The power supply circuit 142 generates electric power (operation power supply) to be supplied to each component, by using electric power from the battery 20, or electric power from the AC adaptor 150 which is connected as an external power supply to the computer main body 11.

FIG. 3 is a perspective view of a tablet computer 40, as viewed from the front. The computer 40 is configured to receive electric power from a battery 20. The computer 40 comprises a computer main body 41, and a touchscreen display 310. The touchscreen display 310 includes a display device such as a liquid crystal display (LCD) 31. In addition, a camera (webcam) 32 is disposed in an end part above the touchscreen display 310.

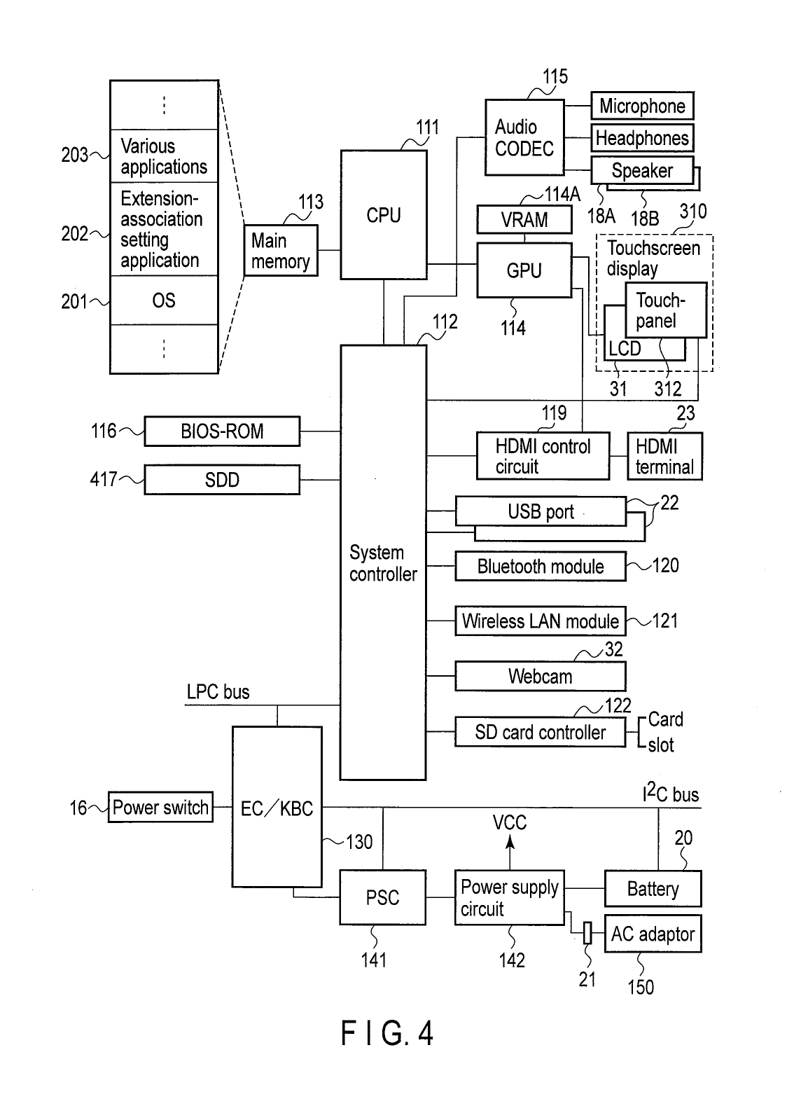

FIG. 4 illustrates system configuration of the computer 40. The computer 40 comprises the touchscreen display 310, a CPU 111, a system controller 112, a main memory 113, a graphics processing unit (GPU) 114, an audio CODEC 115, a BIOS-ROM 116, a solid state drive (SSD) 417, a Bluetooth module 120, a wireless LAN module 121, an SD card controller 122, an embedded controller/keyboard controller IC (EC/KBC) 130, a keyboard backlight 13A, a power supply controller (PSC) 141, and a power supply circuit 142.

Computer 40 does not include keyboard 13, touchpad 14, or RGB port 24, unlike computer 10.

The touchscreen display 310 includes the LCD 31 and a touchpanel 312. The touchpanel 312 is disposed on the LCD 31. The touchpanel 312 is a capacitive pointing device configured to perform input on a screen of the LCD 31. The touchpanel 312 detects a touching position on the screen, in which the finger touches the screen, and movement of the touching position.

A default application, which opens files that include an extension in their file names, is associated with the extension. The default application associated with the extension is changed by using, for example, the item “setting of default application” in the “control panel”. When the default application is changed by the item “setting of default application”, a program is selected from a plurality of programs which are displayed in the item “setting of default application”, and the extension, a file of which is opened by the selected program, is selected. Various types of installed programs are arranged in the item “setting of default application”, which is difficult for the user to understand.

When the default application associated with an extension is changed, the application is changed by using, for example, the item “association of file type or protocol program” in the “control panel”. When the default application is changed by the item “association of file type or protocol program”, an extension is selected from a plurality of extensions, and thereafter a program which is to be associated with the selected extension is selected. When the default application is changed by the item “association of file type or protocol program”, it is necessary to perform setting for each extension.

In the case of opening a file of an extension, with which no default application is associated, when the icon which indicates the file is double-clicked, a window for selecting a program which opens the file is displayed.

The above extension association function is not easy to use for the user. In the computer according to the present embodiment, a default application is automatically associated with an extension by the extension association setting application, according to the system configuration of the computer.

When both a full-screen application and a desktop application are associated with an extension, and the computer can execute the desktop application which is displayed on the desktop on the display screen and the full-screen application which is displayed as a full screen picture on the display screen, both of which can open a file that includes the extension in its file name, the extension association setting application program 202 serving as a default application setting module selects one of the desktop application and the full-screen application as the default application which opens the file, according to the system configuration (hardware configuration) of the computer. The extension association setting application program 202 associates an application which belongs to the selected system (desktop system or full-screen system) as a default application.

For example, the extension association setting application program 202 associates an application of one of the full-screen system or the desktop system with the extension, according to whether the computer has a touchpanel or not.

The following is explanation of a process of associating a default application with an extension, according to whether the computer has a touchpanel or not.

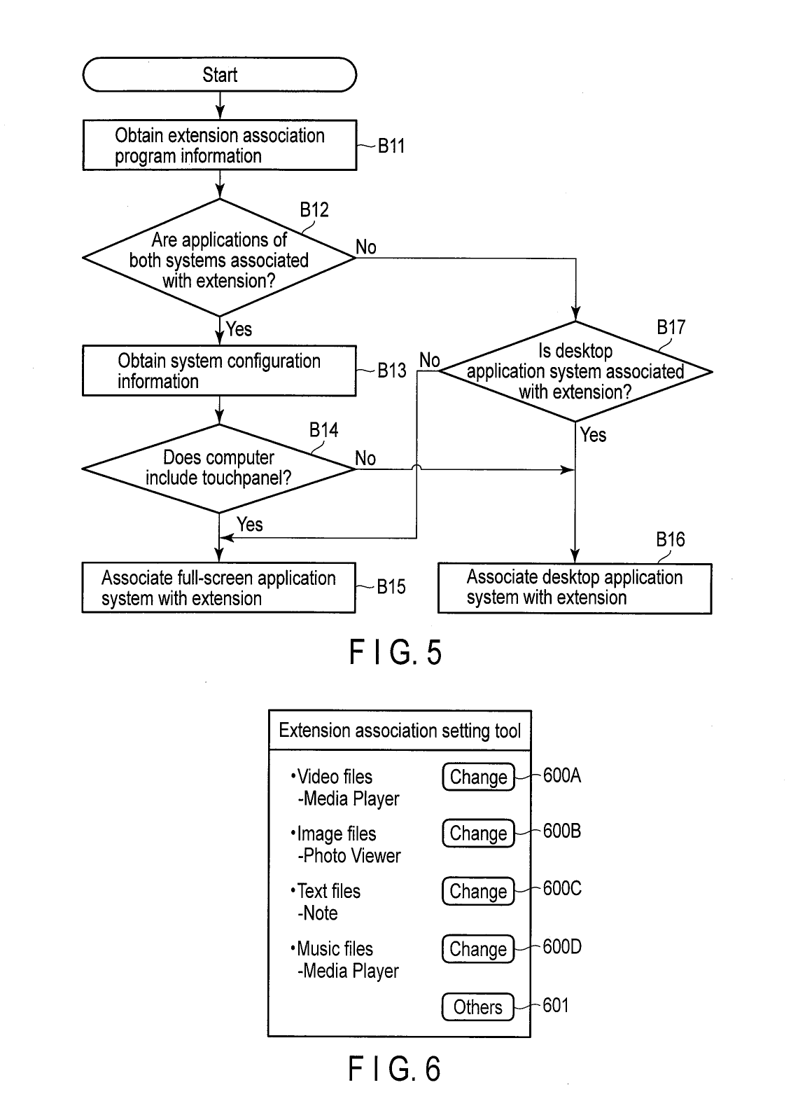

FIG. 5 is a flowchart illustrating a process of associating a default application with an extension.

First, the extension association setting application program 202 requests the operating system 201 to transmit extension association program information which indicates the program that is associated with the extension. The extension association program information indicates programs which can open a file that includes the extension. The extension association program information is stored in a registry. The extension association setting application program 202 obtains the extension association program information which is transmitted from the operating system 201 (Step B11).

The extension association setting application program 202 determines whether applications of both the full-screen system and the desktop system are associated with the extension, based on the extension association program information (Step B12). It can be determined, based on the place (folder) of storing the application, which of the full-screen system and the desktop system the application associated with the extension belongs to.

When it is determined that applications of both systems are associated with the extension (Yes in Step B12), the extension association setting application program 202 requests the operating system 201 to transmit system configuration information which indicates the system configuration of the computer. The extension association setting application program 202 obtains the system configuration information transmitted from the operating system 202 (Step B13).

The extension association setting application program 202 determines whether the computer includes a touchpanel or not, based on the system configuration information (Step B14). When it is determined that the computer includes a touchpanel (Yes in Step B14), the extension association setting application program 202 associates the full-screen application with the extension as the default application (Step B15). When it is determined that the computer includes no touchpanel (No in Step B14), the extension association setting application program 202 associates the desktop application with the extension as the default application (Step B16).

When it is determined that applications of both systems are not associated (No in Step B12), the extension association setting application program 202 determines whether the application associated with the extension is a desktop application or not, based on the extension association program information (Step B17). When it is determined that the associated application is a desktop application (Yes in Step B17), the extension association setting application program 202 associates the desktop application with the extension as the default application (Step B16). When it is determined that the associated application is not a desktop application (No in Step B17), the extension association setting application program 202 associates the full-screen application with the extension as the default application (Step B15).

After default applications are associated with respective extensions, the extension association setting application program 202 displays a window illustrated in FIG. 6 on the LCD 31.

The window illustrated in FIG. 6 shows default applications which are assigned to typical forms. The window shows that Media Player is associated with video files which include an extension of a video form. The window shows that Photo Viewer is associated with image files which include an extension of an image form. The window shows that Note is associated with text files which include an extension of a text form. The window shows that Media Player is associated with music files which include an extension of a music form.

It is possible to change the default applications associated with files, by operating change buttons 600A to 600D. It is also possible to display default applications, which are associated with file forms that are not displayed in the window, by operating an “others” button 601.

Although the default application is selected according to whether the computer includes a touchpanel or not in the above embodiment, one of full-screen application and desktop application may be associated with an extension according to the size of the display screen. When the size of the display screen is larger than a set value, the extension association setting application program 202 associates a desktop application with the extension as the default application. When the size of the display screen is not larger than the set value, the extension association setting application program 202 associates a full-screen application with the extension as the default application. This is because full-screen applications have fonts of a large size and thus can more easily be viewed, in the case where the size of the display screen is not large.

Desktop applications are associated for the user who frequently uses the external output, as the user's usage state.

A default program which has already been associated may be used with priority for an extension with which the default program has already been associated.

In the case of using specifications (such as presence/absence of a touchpanel, and screen size of the internal display) which depend on the apparatus and do not change, the default applications may be set to desktop or full-screen application programs in preinstall.

Although the default application is associated with an extension in the above embodiment, an application which is suitable for an extension may be presented to the user as the default application, and the default application may be associated with the extension after the computer obtains user permission.

### Second Embodiment

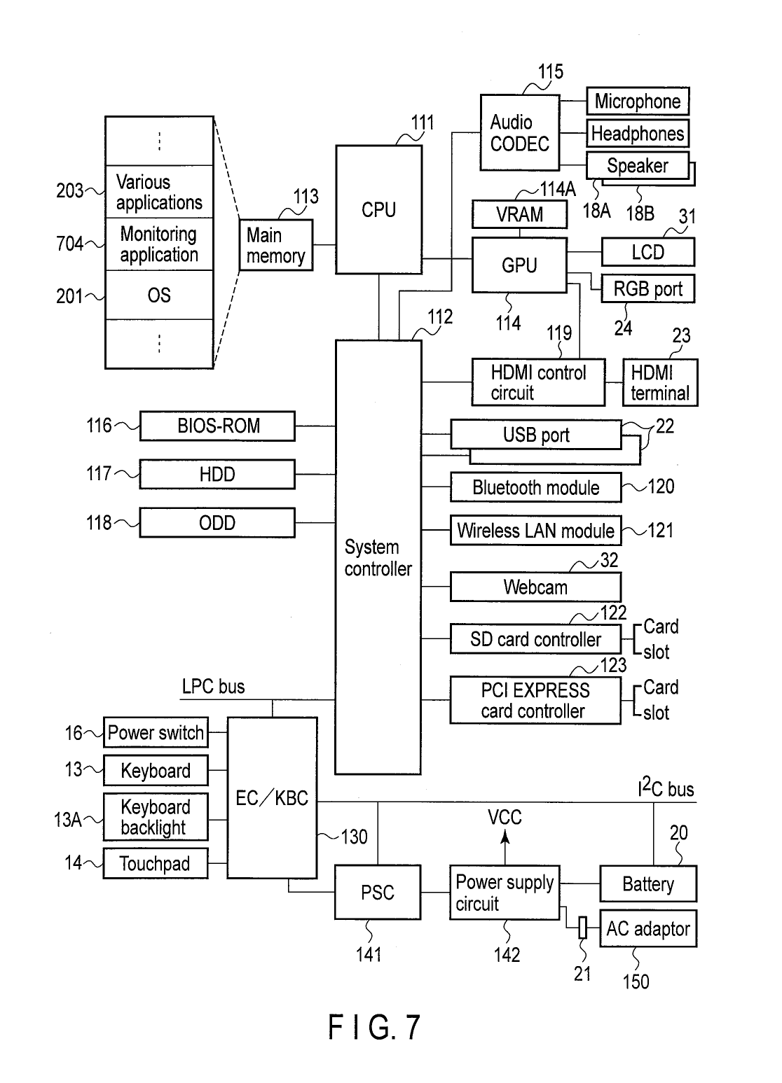

FIG. 7 is a block diagram illustrating system configuration of a computer 10 according to a second embodiment.

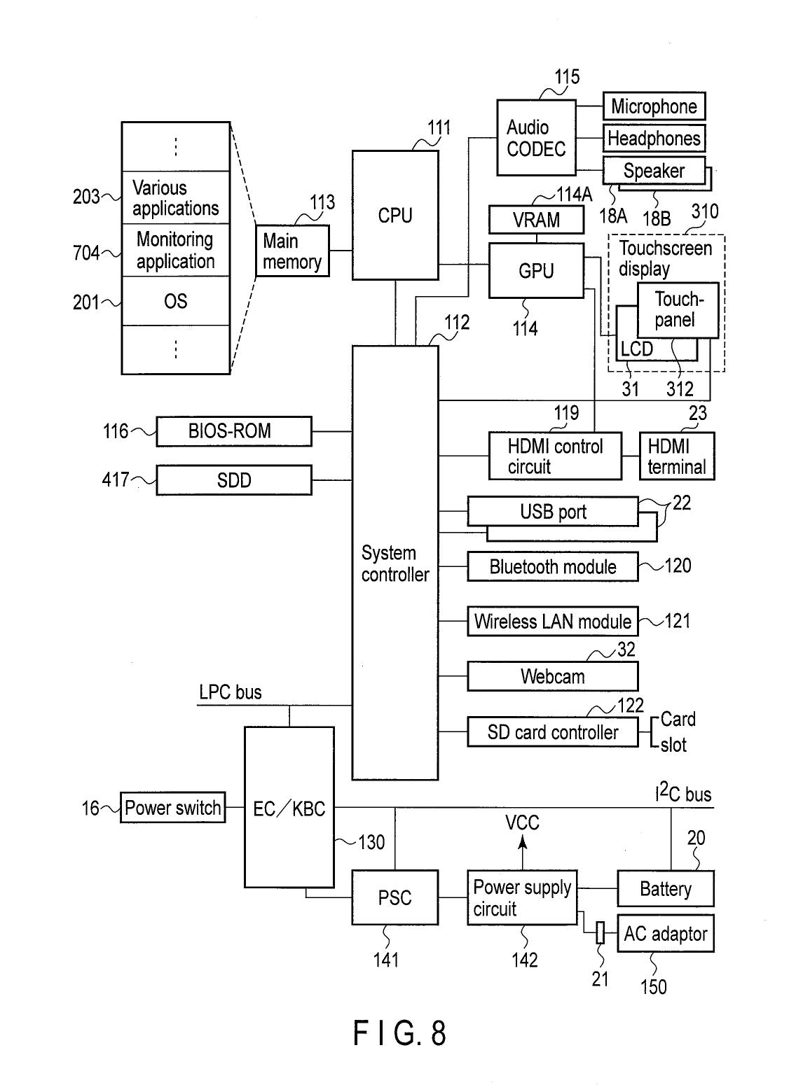

FIG. 8 is a diagram illustrating system configuration of a computer 40 according to the second embodiment.

A CPU 111 of each of the computers 10 and 40 executes a monitoring application 704 serving as a default application setting module. The monitoring application 704 is a resident application. The monitoring application 704 monitors a usage state of applications executed by the electronic apparatus, and provides the user with suggestion to change the default application, based on history of the usage state. When the user gives permission to change the default application in response to the suggestion, the monitoring application 704 changes the default application which is associated with the extension.

The monitoring application 704 selects one of the desktop system and the full-screen system as the default application which opens a file, in accordance with the history of the usage state of the type of application executed by the electronic apparatus 10 or 40. The monitoring application 704 associates an application which belongs to the selected system, as the default application. The monitoring application 704 recommends an application of the selected system, as the default application.

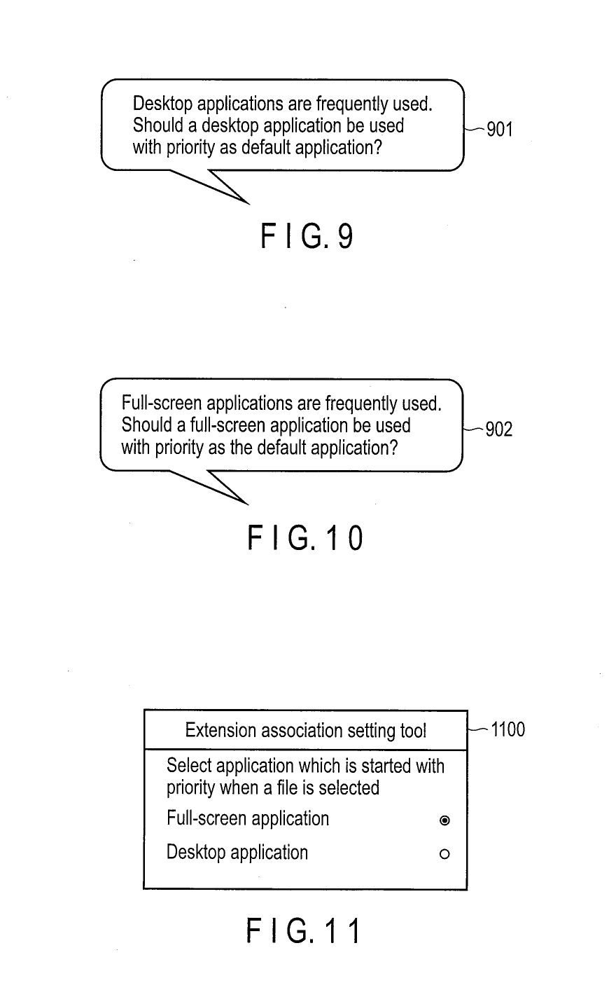

When desktop applications are used more frequently than full-screen applications, the monitoring application 704 recommends a desktop application as default application for an extension which is associated with applications of both the desktop system and the full-screen system. As illustrated in FIG. 9, the monitoring application 704 displays a pop-up window 901 which includes a message “Desktop applications are frequently used. Should a desktop application be used with priority as the default application?” on the display screen to recommend the desktop application.

When full-screen applications are used more frequently than desktop applications, the monitoring application 704 recommends a full-screen application as default application for an extension which is associated with applications of both the desktop system and the full-screen system. As illustrated in FIG. 10, the monitoring application 704 displays a pop-up window 902 which includes a message “Full-screen applications are frequently used. Should a full-screen application be used with priority as the default application?” on the display screen to recommend the full-screen application.

In the case of using system configuration (such as presence/absence of mouse connection, and presence/absence of output to the external display) which is changed by user operation, the monitoring application 704 may monitor the status. The monitoring application 704 recommends the default application in accordance with change of the status, and thereafter changes the default application.

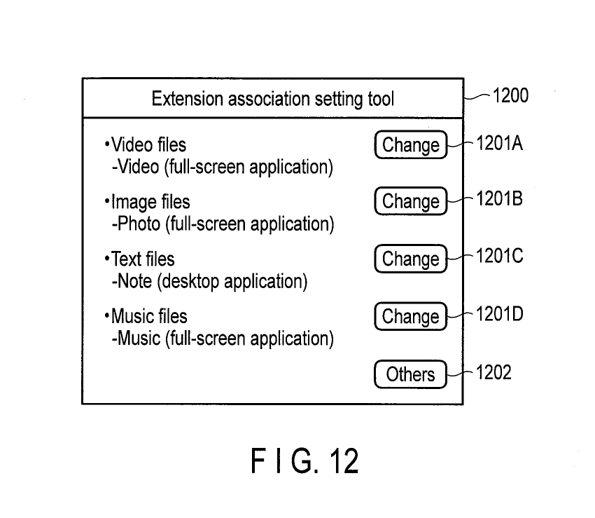

A window 1100 illustrated in FIG. 11 may be displayed on an LCD 31, to cause the user to select the application type which is started with priority when a file is selected. For example, when the user selects full-screen applications and changes the default applications for extensions, a window illustrated in FIG. 12 is displayed on the LCD 31.

The window 1200 illustrated in FIG. 12 shows default applications which are assigned to typical forms. The window shows that the full-screen application “Video” is associated with video files which include an extension of a video form. The window shows that the full-screen application “Photo” is associated with image files which include an extension of an image form. The window shows that the desktop application “Note” is associated with text files which include an extension of a text form. The window shows that the full-screen application “Music” is associated with music files which include an extension of a music form.

It is possible to change the default applications which are associated with files, by operating change buttons 1201A to 1201D. It is also possible to display default applications which are associated with file forms that are not displayed in the window, by operating an “others” button 1202.

The computer of the second embodiment may execute the extension association setting application program 202 of the first embodiment.

One of the desktop system and the full-screen system is selected as the default application which opens a file that includes the extension in its file name, based on at least one of the system configuration of the electronic apparatus and the usage state of applications executed by the electronic apparatus. Thereby, an application of the selected system is associated with an extension, or an application of the selected system is recommended as the default application to be associated with the extension. Thereby, it is possible to associate a program which is suitable for an extension with the extension as the default application, in accordance with the system configuration and the usage state.

Since the process of the present embodiment can be executed by a computer program, the same effect as that of the present embodiment can easily be obtained, only by installing the computer program in a computer through a computer-readable storage medium that stores the computer program and executing the computer program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus configured to execute a desktop application displayed on a display screen on a desktop and a full-screen application displayed as a full-screen picture on the display screen, each of the applications configured to open a file comprising an extension in a file name of the file, the apparatus comprising:
a default application setting selector configured to select one of the desktop application and the full-screen application as a default application configured to open the file, based on at least one of system configuration of the apparatus and a usage state of applications executed by the apparatus, and to associate the selected application with the extension, or recommend the selected application as the default application to be associated with the extension.

2. The apparatus of claim 1, wherein
the default application setting selector is configured to select one of the desktop application and the full-screen application as the default application, in accordance with whether the apparatus comprises a touchpanel.

3. The apparatus of claim 1, wherein
the default application setting selector is configured to select one of the desktop application and the full-screen application as the default application, in accordance with a size of the display screen.

4. The apparatus of claim 1, wherein
the default application setting selector is configured to select one of the desktop application and the full-screen application as the default application, in accordance with frequency in use of desktop applications and frequency in use of full-screen applications.

5. A method of controlling an electronic apparatus configured to execute a desktop application displayed on a display screen on a desktop and a full-screen application displayed as a full-screen picture on the display screen, each of the applications configured to open a file that comprises an extension in a file name of the file, comprising:
selecting one of the desktop application and the full-screen application as a default application configured to open the file, based on at least one of system configuration of the apparatus and a usage state of applications executed by the apparatus; and
associating the selected application with the extension, or recommending the selected application as the default application to be associated with the extension.

6. A computer-readable, non-transitory storage medium comprising a computer program configured to be executed by a computer configured to execute a desktop application displayed on a display screen on a desktop and a full-screen application displayed as a full-screen picture on the display screen, each of the applications configured to open a file that comprises an extension in a file name of the file, the computer program configured to cause the computer to execute functions of:
selecting one of the desktop application and the full-screen application as a default application configured to open the file, based on at least one of system configuration of the computer and a usage state of applications executed by the computer; and
associating the selected application with the extension, or recommending the selected application as the default application to be associated with the extension.
